(19) United States
(12) Patent Application Publication
(10) Pub. No.: US 2006/0236875 A1
(43) Pub. Date: Oct. 26, 2006

(54) Apparatus for holding hot cooking utensils used while cooking outdoors

(76) Inventor: Wallace E. Carr, Cheswick, PA (US)

Correspondence Address: JAMES RAY & ASSOCIATES, 2640 PITCAIRN ROAD, MONROEVILLE, PA, 15146, US

(21) Appl. No.: 11/407,424

(22) Filed: Apr. 20, 2006

Related U.S. Application Data
(60) Provisional application No. 60/673,440, filed on Apr. 21, 2005.

(51) Int. Cl. A23G 1/10

(52) U.S. Cl. 99/485

(57) ABSTRACT

An apparatus that engages a predetermined portion of a pre-selected item and holds at least one hot cooking utensil used while cooking outdoors. The apparatus includes a support rod member having a shelf member either fixedly or adjustably connected thereto via a shelf bracket mechanism. The shelf member holds such at least one hot cooking utensil. The apparatus also includes a clamp mechanism that either is fixedly or adjustably connected to the support rod member for engaging such predetermined portion of such pre-selected item.

### CROSS REFERENCE TO RELATED APPLICATION

This application is closely related to and claims benefit from U.S. Provisional Patent Application Ser. No. 60/673,440 filed on Apr. 21, 2005.

### FIELD OF THE INVENTION

The present invention relates, in general, to an apparatus for holding cooking utensils when not in use and, more particularly, the invention relates to an apparatus that attaches to a predetermined portion of a pre-selected item and holds at least one hot cooking utensil used for cooking outdoors over a campfire or a grill.

### BACKGROUND OF THE INVENTION

People have been enjoying various outdoor activities such as camping, hiking, picnics, etc. for many years. One aspect many people like about these activities is being able to prepare and/or eat food that is cooked outdoors. Cooking hot dogs, hamburgers, steaks, marshmallows and mountain pies over a campfire or a grill can be quite relaxing and enjoyable.

However, the tools that are used to cook these items are quite hot and stay very hot for a long period of time. Finding a place to put the cooking utensils while cooking and even afterwards until they cool down can be annoying. Also, the cooking utensils are quite gritty and dirty during and after use.

Placing these utensils on the ground is unsanitary and not practical. Putting them directly on a tablecloth is not practical either because the hot utensils will probably melt, burn and/or stain the tablecloth, or laying them directly on a table will probably damage the tabletop surface as well.

Therefore, a need exists for an apparatus that is able to safely hold hot cooking utensils while cooking outdoors as well as to provide a convenient place to prepare food items on before cooking such items over the campfire or grill.

### SUMMARY OF THE INVENTION

The present invention provides an apparatus that attaches to a predetermined portion of a pre-selected item, such as a picnic table, outdoor furniture, deck railing, etc., for holding at least one hot cooking utensil used while cooking outdoors. The apparatus includes a support rod member that supports a shelf member. The shelf member is for holding the at least one hot cooking utensil. The shelf member includes a shelf bracket means for one of fixedly and adjustably connecting to the support rod member. The apparatus further includes a clamp means that fixedly or adjustably connects to the support rod member and engages such predetermined portion of such pre-selected item.

### OBJECTS OF THE INVENTION

It is, therefore, one of the primary objects of the present invention to provide an apparatus that holds hot cooking utensils used while cooking outdoors over a campfire or on a grill.

Another object of the present invention is to provide an apparatus for holding hot cooking utensils that can easily attach to a portion of outdoor furniture in close proximity to a cooking area like a campfire or a grill.

Still another object of the present invention is to provide an apparatus for holding hot cooking utensils that can be adjusted to fit onto portions of outdoor furniture having various dimensions.

Yet another object of the present invention is to provide an apparatus for holding hot cooking utensils that provides an alternative to placing such utensils on the ground or nearby piece of outdoor furniture during or after using them.

An even further object of the present invention is to provide an apparatus for holding hot cooking utensils that provides a convenient place to prepare food items on before cooking such items over a campfire or a grill.

In addition to the above described objects and advantages of the present invention, various other objects and advantages of the outdoor hot cooking utensil holding apparatus will become more readily apparent to those persons skilled in such art from the following more detailed description, particularly, when such description is taken in conjunction with the attached drawing figures and with the appended claims.

### BRIEF DESCRIPTION OF THE DRAWINGS

FIG. 1 is a front elevation view of an outdoor hot cooking utensil holding apparatus according to a presently preferred embodiment of the present invention;

FIG. 2 is a side elevation view of the outdoor hot cooking utensil holding apparatus illustrated in FIG. 1;

FIG. 3 is a top elevation view of the outdoor hot cooking utensil holding apparatus; and

FIG. 4 is a perspective view showing the outdoor hot cooking utensil holding apparatus engaged with a portion of a picnic table.

### DETAILED DESCRIPTION OF THE PRESENTLY PREFERRED AND VARIOUS ALTERNATIVE EMBODIMENTS OF THE INVENTION

Prior to proceeding to the more detailed description of the invention, it should be noted that, for the sake of clarity, identical components, having identical functions have been identified with identical reference numerals throughout the several drawing figures.

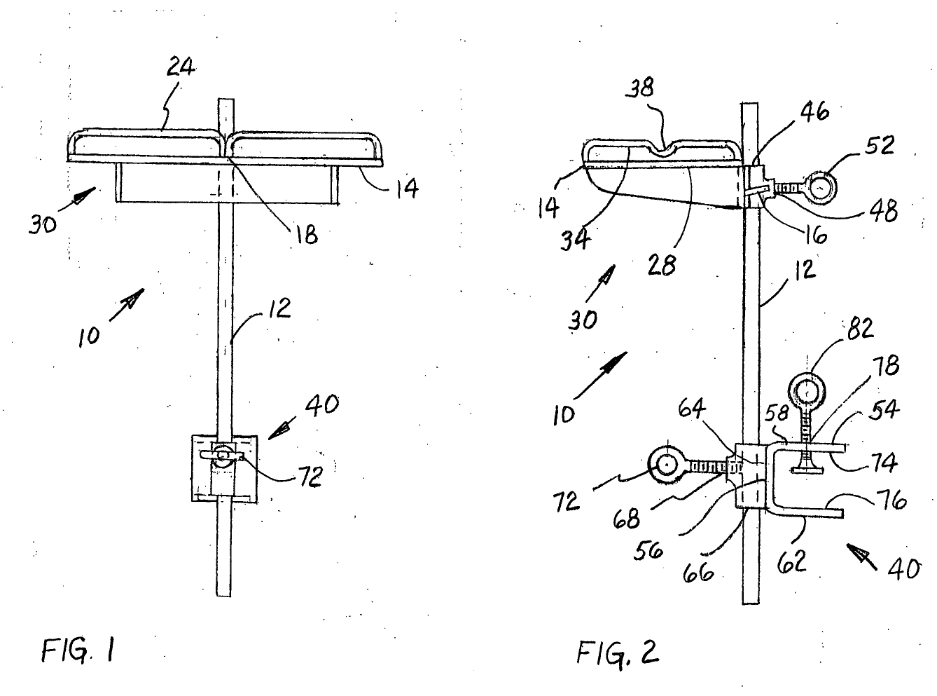

Referring now, more particularly, to FIGS. 1-4 of the drawings, there is illustrated an apparatus, generally designated 10, that attaches to a predetermined portion of a pre-selected item, generally designated 20, such as a picnic table, lawn furniture, patio furniture and a deck railing, and holds at least one hot cooking utensil, generally designated 50, used while cooking outdoors. The apparatus 10 includes a support rod member 12 connected to a shelf member 14 which holds such at least one hot cooking utensil 50.

The shelf member 14 has a shelf bracket means, generally designated 30, that either fixedly or adjustably connects to the support rod member 12. The apparatus 10 also includes a clamp means, generally designated 40, that one of fixedly and adjustably connects to the support rod member 12 and engages such predetermined portion of such pre-selected item 20.

In a presently preferred embodiment of the apparatus 10, at least one of the shelf member 14 and the shelf bracket means 30 has at least two outwardly projecting prong members 16 closely spaced together for holding at least one hot cooking utensil 50.

The support rod member 12, preferably, is at least about thirty inches long and ranges from between about one-quarter inch and three-quarters inch in diameter. Also, the shape of the support rod member 12 is, preferably, either round or square.

In another presently preferred embodiment of the inventive apparatus 10, the shelf member 14 will have a rail member along an outer perimeter of each one of a first longitudinal side 18 and a second longitudinal side 22 of the shelf member 14. The first longitudinal side 18 and the second longitudinal side 22 are, preferably, at least about seven inches in length. Also, the rail member 24 of the first longitudinal side 18 and the rail member 26 of the second longitudinal side 22 are, preferably, about one-half inch in height.

In still another presently preferred embodiment of the apparatus 10, the shelf member 14 will have a rail member along an outer perimeter of each one of a first latitudinal side 28 and a second latitudinal side 32 of the shelf member 14. The first latitudinal side 28 and the second latitudinal side 32 are, preferably, wide enough to hold at least one of a single pie iron and a double pie iron cooking utensil. The rail member 34 of the first latitudinal side 28 is, preferably, about one-half inch in height, and the rail member 36 of the second latitudinal side 32 is, preferably, about one-quarter inch in height.

In addition, the rail member 34 of the first latitudinal side 28, preferably, has a recess 38 intermediate, preferably midway, a length thereof such that a handle 42 of a pie iron®, a registered trademark of Rome Industries Inc., 44 may be placed thereon to prevent the handle 42 from sliding along such length of the rail member 34 of such first latitudinal side 28.

The shelf bracket means 30 of the apparatus 10, preferably, has both a vertically aligned aperture 46 for slidably fitting the support rod member 12 therethrough and a horizontally aligned aperture 48, which intersects the vertically aligned aperture 46, for threadedly fitting a first hand screw 52 therein to abut against such support rod member 12 and thus adjustably connect the shelf member 14 to such support rod member 12. Also, the shelf member 14 is able to rotate 360° around the support rod member 12 when the first hand screw 52 is loosened from abutting against such support rod member 12.

The clamp means 40 of the apparatus 10, preferably, includes a U-shaped bracket member 54 having a bottom wall portion 56 and two side wall portions 58 and 62, each of said bottom 56 and side wall portions 58 and 62 having a front portion and a back portion.

The back portion 64 of the bottom wall portion 56 of such U-shaped bracket member 54 has a vertically aligned aperture 66 for slidably fitting the support rod member 12 therethrough and a horizontally aligned aperture 68, which intersects such vertically aligned aperture 66, for threadedly fitting a second hand screw 72 therein to abut against the support rod member 12 and thus adjustably connect the clamp means 40 to such support rod member 12.

Also, preferably, the two front portions 74 and 76 of the side wall portions 58 and 62, respectively, of such U-shaped bracket member 54 have a distance of at least about two and one-quarter inches between them. At least one of the side wall portions 58 and 62 of the U-shaped bracket member 54 has an aperture 78 therethrough for threadedly fitting a third hand screw 82 therein to abut against a predetermined surface of such predetermined portion of such pre-selected item 20 and thus adjustably connect the clamp means 40 to such pre-selected item when a thickness of such predetermined portion is less than the at least about two and one-quarter inches.

In yet another presently preferred embodiment, the apparatus 10 may be constructed from one of metal, plastic and various combinations thereof.

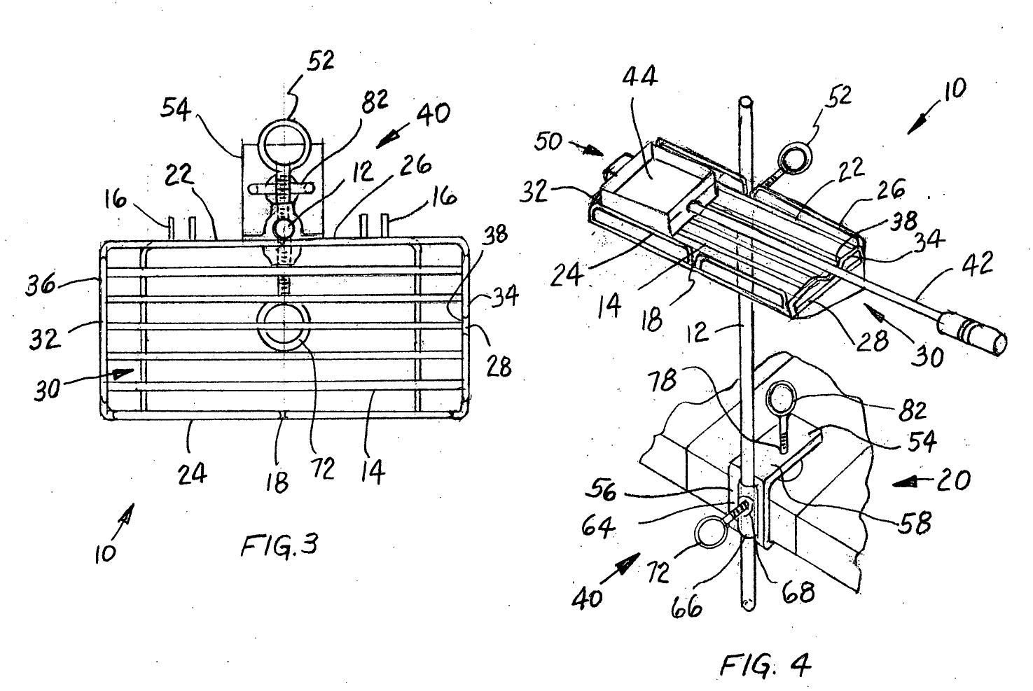

And finally, some other possible cooking utensils 50, besides the pie iron® 44 shown in FIG. 4, that the apparatus 10 is capable of holding when cooking outdoors are a hot dog fork (not shown), a spatula (not shown) and a skewer (not shown).

While the presently preferred embodiments of the invention have been discussed in considerable detail above, it should be obvious to those persons who are skilled in the art that various modifications and adaptations of the present invention can be made without departing from the spirit of the invention and the scope of the appended claims.

I claim:

1. An apparatus engageable with a predetermined portion of a pre-selected item for holding at least one hot cooking utensil used while cooking outdoors, said apparatus comprising:
(a) a support rod member;
(b) a shelf member for holding such at least one hot cooking utensil;
(c) a shelf bracket means engageable with said shelf member for one of fixedly and adjustably connecting said shelf member to said support rod member; and
(d) a clamp means one of fixedly and adjustably connected to said support rod member for engaging such predetermined portion of such pre-selected item.

2. An apparatus, according to claim 1, wherein at least one of said shelf member and said shelf bracket means includes at least two outwardly projecting prong members closely spaced together for holding at least one hot cooking utensil.

3. An apparatus, according to claim 1, wherein a shape of said support rod member is one of round and square.

4. An apparatus, according to claim 1, wherein said support rod member has a length of at least about thirty inches and a diameter ranging from between about one-quarter inch and three-quarters inch.

5. An apparatus, according to claim 1, wherein said shelf member includes a rail member along an outer perimeter of each one of a first longitudinal side and a second longitudinal side of said shelf member.

6. An apparatus, according to claim 5, wherein said first longitudinal side and said second longitudinal side are at least about seven inches in length.

7. An apparatus, according to claim 5, wherein said rail member of said first longitudinal side and said rail member of said second longitudinal side are about one-half inch in height.

8. An apparatus, according to claim 1, wherein said shelf member includes a rail member along an outer perimeter of each one of a first latitudinal side and a second latitudinal side of said shelf member.

9. An apparatus, according to claim 8, wherein said first latitudinal side and said second latitudinal side are wide enough to hold at least one of a single pie iron and a double pie iron cooking utensil.

10. An apparatus, according to claim 8, wherein said rail member of said first latitudinal side is about one-half inch in height and said rail member of said second latitudinal side is about one-quarter inch in height.

11. An apparatus, according to claim 10, wherein said rail member of said first latitudinal side has a recess disposed intermediate a length thereof such that a handle of a pie iron may be placed thereon to prevent such handle from sliding along said length of said rail member of said first latitudinal side.

12. An apparatus, according to claim 1, wherein said shelf bracket means includes a vertically aligned aperture for slidably fitting said support rod member therethrough and a horizontally aligned aperture, which intersects said vertically aligned aperture, for threadedly fitting a first hand screw therein to abut against said support rod member and thus adjustably connect said shelf member to said support rod member.

13. An apparatus, according to claim 12, wherein said shelf member is capable of being rotated 360° around said support rod member when said first hand screw is loosened from said support rod member.

14. An apparatus, according to claim 1, wherein said clamp means includes a U-shaped bracket member having a bottom wall portion and two side wall portions, each of said bottom and side wall portions having a front portion and a back portion.

15. An apparatus, according to claim 14, wherein said back portion of said bottom wall portion of said U-shaped bracket member includes a vertically aligned aperture for slidably fitting said support rod member therethrough and a horizontally aligned aperture, which intersects said vertically aligned aperture, for threadedly fitting a second hand screw therein to abut against said support rod member and thus adjustably connect said clamp means to said support rod member.

16. An apparatus, according to claim 14, wherein a distance between said two front portions of said side wall portions of said U-shaped bracket member is at least about two and one-quarter inches.

17. An apparatus, according to claim 16, wherein at least one of said side wall portions of said U-shaped bracket member includes an aperture therethrough for threadedly fitting a third hand screw therein to abut against a predetermined surface of such predetermined portion of such pre-selected item and thus adjustably connect said clamp means to such pre-selected item when a thickness of such predetermined portion is less than said at least about two and one-quarter inches.

18. An apparatus, according to claim 1, wherein said apparatus is constructed from one of metal, plastic and various combinations thereof.

19. An apparatus, according to claim 1, wherein such pre-selected item includes at least one of a picnic table, lawn furniture, patio furniture and a deck railing.

20. An apparatus, according to claim 1, wherein such cooking utensils include at least one of a pie iron, a hot dog fork, a spatula and a skewer.
